(19) United States
(12) Patent Application Publication
(10) Pub. No.: US 2021/0027756 A1
(43) Pub. Date: Jan. 28, 2021

(54) SOUND TRANSDUCER

(71) Applicant: Robert Bosch GmbH, Stuttgart (DE)

(72) Inventors: Andre Gerlach, Leonberg-Hoefingen (DE); Bernd Scheufele, Koengen (DE); Johannes Henneberg, Weil Im Schoenbuch (DE); Marko Liebler, Bretten (DE)

(21) Appl. No.: 16/967,916

(22) PCT Filed: Apr. 4, 2019
(86) PCT No.: PCT/EP2019/058506

§ 371 Date: Aug. 6, 2020

(30) Foreign Application Priority Data
Apr. 12, 2018 (DE) 10 2018 205 527.0

(51) Int. Cl. G10K 9/122; B06B 1/06; H04R 7/04; G10K 9/22

(52) U.S. Cl. CPC G10K 9/122; G10K 9/22; H04R 7/04; B06B 1/0644

(57) ABSTRACT

A sound transducer, which includes a diaphragm cup, a transducer element, and a housing. The diaphragm cup includes a diaphragm and a wall. The diaphragm, the wall of the diaphragm cup, and at least a part of the housing are formed in one piece from a plastic. In at least one first area of the diaphragm cup, the plastic is filled with a first filler. An ultrasonic sensor including the sound transducer is also provided.

### FIELD

The present invention relates to a sound transducer, including a diaphragm cup, a transducer element, and a housing, the diaphragm cup including a diaphragm and a wall.

### BACKGROUND INFORMATION

Ultrasonic sensors are used in, among other things, automobile applications and industrial applications for detecting surroundings. Objects in the surroundings may be identified by an ultrasonic signal being emitted by the ultrasonic sensor and the ultrasonic echo reflected by an object being received again. The distance to the object may then be calculated based on the propagation time between the emission of the ultrasonic signal and the reception of the ultrasonic echo and on the known sound velocity.

The ultrasonic sensors typically include a sound transducer that includes a diaphragm, a transducer element, and a housing. The transducer element is a piezo-ceramic element, for example, which causes the diaphragm to oscillate upon application of a voltage or converts the oscillations on the diaphragm excited by the sound pressure in front of the diaphragm into an electrical signal for receiving ultrasonic echoes. Such sound transducers are described, for example, in German Patent Application No. DE 10 2012 201 884 A1. Such ultrasonic sensors may be formed in one piece from a plastic.

Based on the foregoing, an object of the present invention is to develop a sound transducer, whose oscillation behavior may be more easily adjusted by the diaphragm and diaphragm cup.

### SUMMARY

In accordance with the present invention, a sound transducer is provided. According to an example embodiment of the present invention, the sound transducer includes a diaphragm cup, a transducer element, and a housing. The diaphragm cup itself includes a diaphragm and a wall. The diaphragm, the wall of the diaphragm cup and at least a part of the housing are formed in one piece from a plastic. Examples of such a plastic are epoxy resin, polyurethane or polyoxymethylene. The plastic in this case refers to a matrix material, i.e., corresponding to the base material of the sound transducer. By using such a uniform matrix material, it is possible, for example, in merely one process, to produce the sound transducer in one piece. In at least one first area of the diaphragm cup, the plastic from which the diaphragm, the wall of the diaphragm cup, and at least a part of the housing are formed in one piece, is filled with a first filler. By filling the plastic with the first filler in the at least one first area of the diaphragm cup, it is possible to easily adapt the oscillation behavior of the diaphragm cup to the respective particular application. Areas of the diaphragm cup, which are intended to also oscillate less intensively when the diaphragm is excited by ultrasonic signals, may in this context be filled with a filler, for example, and thus exhibit a higher inner attenuation than areas without the filler. Options for manufacturing such a sound transducer are, for example, the multi-material injection molding method or the injection method. With the structural design of the associated tool and a provided temporal sequence of the injection, it is possible to produce different areas in the sound transducer.

The plastic, from which the diaphragm cup is formed in one piece, is preferably not completely filled with the first filler. At least one second area of the diaphragm cup is formed, which is free of any fillers. Thus, for example, the plastic may be filled with the first filler in the area of the wall of the diaphragm cup, but the plastic in the area of the diaphragm may be free of the first filler. In this way, it is possible to prevent or at least reduce undesirable oscillations of the wall. In this context, there is also the option of filling areas of the diaphragm cup that require no high level of functionality as compared to other areas that include so-called inactive fillers. As materials, such inactive fillers are significantly less expensive than the plastic material and also serve to stretch the plastic. Alternatively or in addition, at least one third area of the diaphragm cup is formed, within which the plastic is filled with a second filler, which differs from the first filler. This results in a further possibility for adjusting the oscillation behavior of the diaphragm cup. For example, the plastic may be filled in particular areas of the diaphragm with fillers differing from one another in order to thereby achieve a particular, desired directional characteristic of the sound transducer. The volume fraction of the fillers in the first and/or third area of the diaphragm cup is between 5 and 80 percent. The volume fraction of the fillers is preferably between 15 and 60 percent. The volume fraction in the first and third area of the diaphragm cup may each be the same or different.

The first filler or second filler is preferably short fibers. Short fibers have the advantage of a relatively high modulus of elasticity with a simultaneously low weight compared to other possible fillers. Thus, for example, a design of the wall of the diaphragm cup having a lower wall thickness compared to walls made of plastic with no filling is possible with short fibers. Alternatively, the first and the second filler may be short fibers. Thus, for example, the plastic in one area of the diaphragm cup may be filled with cut carbon fibers and at least partly with short glass fibers in a second area. Short fibers made essentially of carbon have a higher modulus of elasticity compared to the short glass fibers and are therefore preferred for areas in which a higher stiffness is required. In contrast, short glass fibers exhibit a higher tensile strength and compressive strength, which may ensure a stiffening of the plastic while simultaneously maintaining a certain flexibility.

The first filler or second filler is preferably at least one material that has higher density than the plastic, from which the diaphragm, the wall of the diaphragm cup, and at least a part of the housing are formed in one piece. One example thereof is metal powder made of aluminum and/or brass and/or stainless steel. The particles of the metal powder in this case may have a symmetrical shape in the form of a sphere, for example. Alternatively, the particles of the metal powder may, however, also have a non-symmetrical shape. The particle size is preferably smaller than the smallest dimension of the sound transducer. A plastic filled with such a filler has a greater density and stiffness as compared to an unfilled plastic. By increasing the density and stiffness, it is possible, for example, to increase the acoustic impedance of particular areas of the diaphragm cup. A plastic filled with such a filler also has an enhanced robustness, for example, against the penetration of foreign particles. Thus, for example, areas not closed off to the outer surroundings may be filled with such a filler as protection against foreign particles. The impact of the above described effects is pronounced to varying degrees as a function of the metal from which the metal powder is formed. Thus, for example, aluminum has a lower density and a lower modulus of elasticity than brass. Thus, it may also be that the first filler and second filler involve at least one material that has a higher density than the plastic from which the diaphragm, the wall of the diaphragm cup, and at least a part of the housing are formed in one piece. A first area, which is intended to exhibit a high level of protection against the penetration of foreign particles, may, for example, be formed from a plastic filled with brass powder. A second area of the diaphragm cup which, by comparison, requires no high level of protection against the penetration of foreign particles may, for example, be filled with a filler that is comparatively inexpensive to manufacture.

The first filler or the second filler preferably involves at least one material, which has a lower density than the plastic from which the diaphragm, the wall of the diaphragm cup, and at least a part of the housing are formed in one piece. This involves, in particular, air-filled glass hollow bodies or air-filled plastic hollow bodies. The plastic from which the plastic hollow bodies are formed may, for example, be the same plastic from which the diaphragm, the wall of the diaphragm cup, and at least a part of the housing are formed as a single piece. Alternatively, it may however also be a different plastic. The hollow bodies in this case may have a symmetrical shape in the form of, for example, a sphere or a hollow fiber. Alternatively, the hollow bodies may also have a non-symmetrical shape. The hollow body size is preferably smaller than the smallest dimension of the sound transducer. A plastic filled with such a filler has a lower density and stiffness as compared to an unfilled plastic. By reducing the density and stiffness, it is possible, for example, to reduce the acoustic impedance of particular areas of the diaphragm cup. In this way, the directional characteristic of the diaphragm of the diaphragm cup may be adjusted, for example. The first and second filler may also be a material that has a lower density than the plastic, from which the diaphragm, the wall of the diaphragm cup and at least one part of the housing are formed in one piece. Air-filled glass hollow bodies are less expensive to manufacture than air-filled plastic hollow bodies, for example, but in return have a lower density and stiffness than air-filled plastic bodies. These different properties may be utilized for different areas of the diaphragm cup.

The diaphragm of the diaphragm cup is preferably at least partially formed from the plastic filled with the first filler. This results in diverse possibilities for designing the diaphragm. For example, the plastic may be filled with a first filler at least in an inner, circular area of the diaphragm. In this way, for example, the impedance of the diaphragm may be adapted to the respective particular application. The plastic may also be filled with a first filler in an inner elliptical area of the diaphragm, for example. In this way, the directional characteristic of the diaphragm may be optimized. The plastic is preferably free of fillers in the area of the wall of the diaphragm cup and of the at least one part of the housing. This results in an inexpensive sound transducer.

The present invention also provides an ultrasonic sensor including the previously described sound transducer.

### BRIEF DESCRIPTION OF THE DRAWINGS

FIGS. 1 through 8 schematically show various specific example embodiments of a sound transducer according to the present invention.

FIG. 9 schematically shows an ultrasonic sensor according to an example embodiment of the present invention.

### DETAILED DESCRIPTION OF EXAMPLE EMBODIMENTS

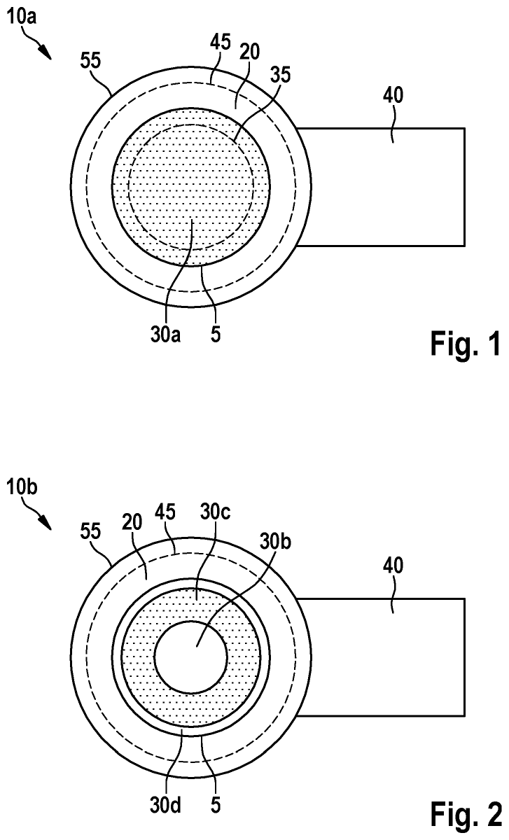

FIG. 1 shows a top view of a first specific embodiment of sound transducer 10a according to the present invention. Dashed line 35 in this case is intended to represent the inner surface of the wall of the diaphragm cup not apparent in the top view. Additional dashed line 45 in this case represents the inner surface of a part of housing 40 not apparent in this top view.

The plastic from which diaphragm 5, the wall of diaphragm cup 20 and at least one part of housing 40 of sound transducer 10a are formed in one piece, is filled in this first specific embodiment completely with a first filler in a first area 30a corresponding to diaphragm 5. The first filler is a material that has a higher density than the plastic from which diaphragm 5, the wall of diaphragm cup 20, and at least a part of housing 40 are formed in one piece. The first filler may, for example, be a metal and/or a ceramic. With this design, it is possible not only to reduce the transmission of oscillations to housing part 40, but it is also possible to adjust the mechanical properties of diaphragm 5 in such a way that a particular, predefined emission behavior is achieved. In addition, the robustness of diaphragm 5 against the penetration of foreign particles into the interior of sound transducer 10a is thereby increased.

FIG. 2 shows a second specific embodiment of sound transducer 10b according to the present invention in a top view. In contrast to the first specific embodiment of sound transducer 10a in FIG. 1a, the plastic in this case is filled with short fibers as a first filler in a first circular area 30b in the center of diaphragm 5. In a second area 30c, which surrounds first area 30b in a circular manner, the plastic is filled with a second filler that has a higher density than the plastic from which diaphragm 5, the wall of diaphragm cup 20, and at least one part of housing 40 are formed in one piece. In an outer edge 30d of diaphragm 5, as well as in the rest of sound transducer 10b, the plastic in this case is again filled with the first filler. The design of the sound transducer including diaphragm 5 variously reinforced in particular areas offers the possibility of implementing two or more resonant operating frequencies having different directional characteristics of the sound emission and of the sound reception. Multiple operating frequencies may be utilized with the aid of suitable electronics, in order to select a suitable directional characteristic depending on the situation.

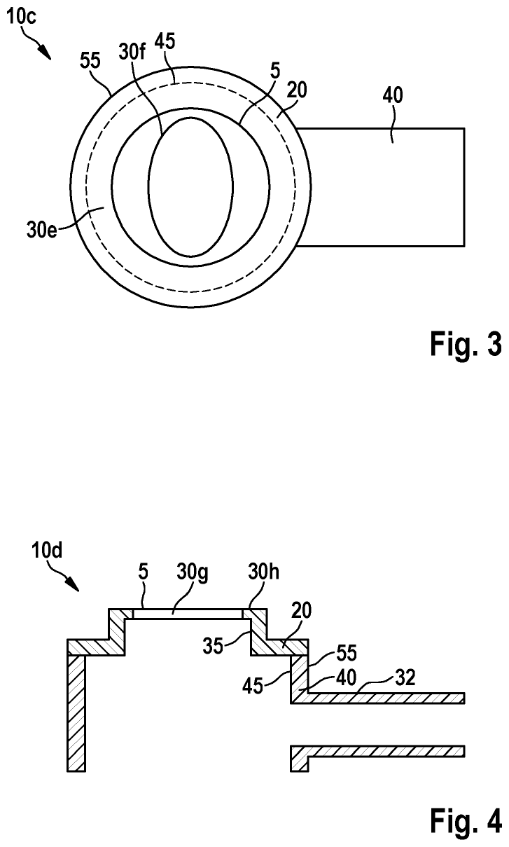

FIG. 3 shows a third specific embodiment of sound transducer 10c in a top view. In this case, the plastic is filled in a first elliptical area 30f in the center of diaphragm 5 with a first filler, which has a lower density than the plastic from which diaphragm 5, the wall of diaphragm cup 20, and at least one part of housing 40 are formed in one piece. In a third area in the rest of sound transducer 10c, the plastic in this case is free of fillers. Here, too, the mechanical properties of diaphragm 5 may be adjusted in such a way that a particular, predefined emission behavior is achieved.

FIG. 4 shows a fourth specific embodiment of sound transducer 10d according to the present invention in a longitudinal section. In this case, the plastic is filled in a first area 30g in the center of diaphragm 5 with a first filler, which has a lower density than the plastic from which diaphragm 5, the wall of diaphragm cup 20, and at least a part of housing 40 are formed in one piece. In contrast, the plastic in a second area 30h in the edge area of the diaphragm and in the area of the wall of diaphragm cup 20 is filled with a second filler, which has a higher density than the plastic from which diaphragm 5, the wall of diaphragm cup 20, and at least a part of housing 40 are formed in one piece. In a third area in sensor housing 40, the plastic in this case is free of fillers. With this design of the sound transducer, it is possible, for example, to prevent the oscillations of diaphragm 5 from propagating onto diaphragm cup 20 and further onto sensor housing 40.

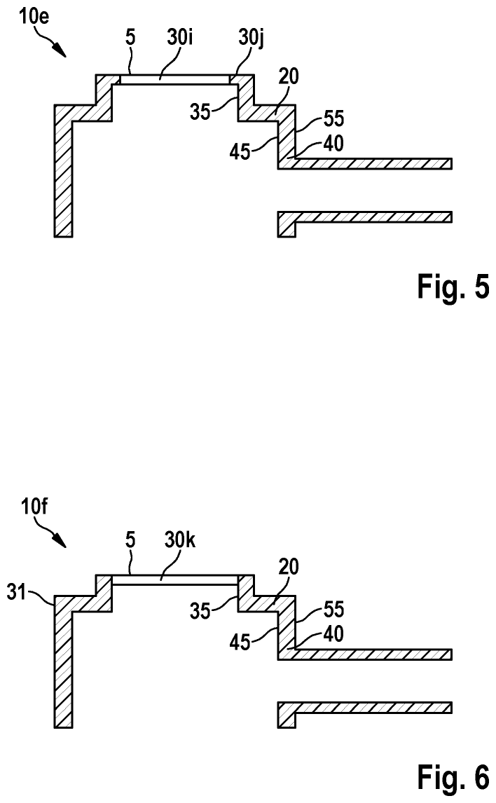

FIG. 5 shows a fifth specific embodiment of sound transducer 10e according to the present invention in a longitudinal section. In contrast to the fourth specific embodiment in FIG. 4, the plastic in this case is filled with short fibers in edge area 30j of diaphragm 5, in the wall of diaphragm cup 20 and in the part of sensor housing 40.

In FIG. 6, the plastic, again in contrast to the fifth specific embodiment in FIG. 5, is filled completely with the first filler in a first area 30k corresponding to diaphragm 5. The first filler in this case has a lower density than the plastic from which diaphragm 5, the wall of diaphragm cup 20 and at least one part of housing 40 are formed in one piece.

With the specific embodiments of sound transducer 10e and 10f shown in FIGS. 5 and 6 as well, it is possible, for example, to prevent the diaphragm cup and sensor housing from resonating during an oscillation of the diaphragm.

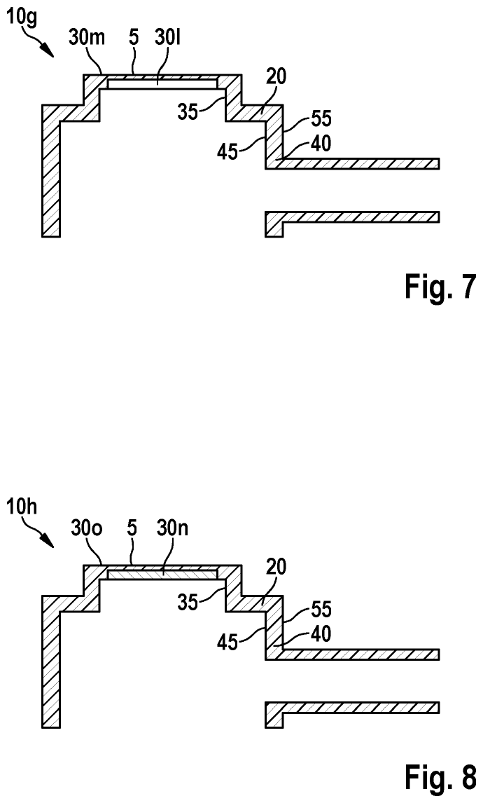

In contrast to the preceding specific embodiments, FIG. 7 shows a sound transducer 10g, in which diaphragm 5 is formed at least partially in two layers. The plastic in this case is filled with a first filler in a first area, in a lower layer 301 of diaphragm 5, which is directed toward the inner side of sound transducer 10g. The first filler in this case has a lower density than the plastic from which diaphragm 5, the wall of diaphragm cup 20, and at least a part of housing 40 are formed in one piece. In contrast, the plastic is filled with short fibers in a second layer 30m of diaphragm 5, which is directed toward the outer surroundings of sound transducer 10g. In contrast, FIG. 8 shows a further design possibility, in which however lower layer 30n of diaphragm 5 is filled with a first filler, which has a higher density than the plastic from which diaphragm 5, the wall of diaphragm cup 20, and at least one part of housing 40 are formed in one piece. With the two-layered design of the diaphragm, it is possible in both cases to produce impedance adaption layers for using the sound transducer, for example, in water.

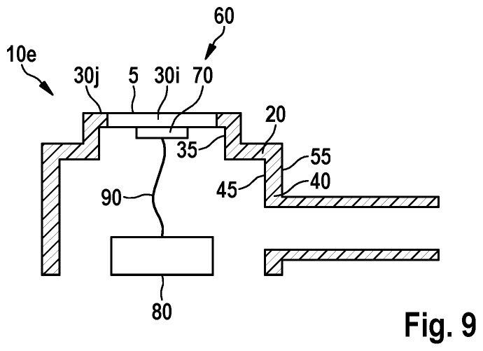

FIG. 9 schematically shows in a longitudinal section one specific embodiment of ultrasonic sensor 60 according to the present invention. In this case, ultrasonic sensor 60 includes sound transducer 10e according to FIG. 5. It could, however, also include any other sound transducer shape according to the preceding specific embodiments. Ultrasonic sensor 60 in this case also includes a transducer element 70 in the form of a piezo element, which is situated on the underside of diaphragm 5e. Transducer element 70 in this case is connected to electronic components 80 of ultrasonic sensor 60 via a connecting cable 90. Electronic components 90 of ultrasonic sensor 60 may, for example, be a circuit board and/or a processing unit of ultrasonic sensor 60.

1-9. (canceled)

10. A sound transducer, comprising:
a diaphragm cup;
a transducer element; and
a housing, the diaphragm cup including a diaphragm and a wall, the diaphragm, the wall of the diaphragm cup, and at least a part of the housing being formed in one piece from a plastic;
wherein the plastic is filled with a first filler in at least one first area of the diaphragm cup.

11. The sound transducer as recited in claim 10, wherein at least one second area of the diaphragm cup is formed of the plastic, the plastic in the at least one second area of the diaphragm cup being free of fillers.

12. The sound transducer as recited in claim 10, wherein at least one third area of the diaphragm cup is formed of the plastic, the plastic in the at least one third area being filled with a second filler differing from the first filler in the plastic in the at least one first area of the diaphragm cup.

13. The sound transducer as recited in claim 12, wherein the first filler and/or the second filler is short fibers.

14. The sound transducer as recited in claim 12, wherein the first filler or the second filler is a metal and/or a ceramic, which has a higher density than the plastic from which the diaphragm, the wall of the diaphragm cup, and at least one part of the housing are formed in one piece.

15. The sound transducer as recited in claim 12, wherein the first filler or second filler is air-filled glass hollow bodies and/or air-filled plastic hollow bodies, which have a lower density than the plastic from which the diaphragm, the wall of the diaphragm cup, and at least one part of the housing are formed in one piece.

16. The sound transducer as recited in claim 10, wherein the diaphragm of the diaphragm cup is made at least partially from the plastic filled with the first filler.

17. The sound transducer as recited in claim 16, wherein the wall of the diaphragm cup and the at least a part of the housing are free of fillers.

18. An ultrasonic sensor, comprising:
a sound transducer including:
a diaphragm cup;
a transducer element; and
a housing, the diaphragm cup including a diaphragm and a wall, the diaphragm, the wall of the diaphragm cup, and at least a part of the housing being formed in one piece from a plastic;
wherein the plastic is filled with a first filler in at least one first area of the diaphragm cup.
